(19) United States
(12) Patent Application Publication
(10) Pub. No.: US 2011/0119370 A1
(43) Pub. Date: May 19, 2011

(54) MEASURING NETWORK PERFORMANCE FOR CLOUD SERVICES

(75) Inventors: Cheng Huang, Redmond, WA (US); Jin Li, Bellevue, WA (US); Felix D. Livni, Seattle, WA (US); Gary W. Hall, Kirkland, WA (US); Yunxian A. Wang, Hauppauge, NY (US); Keith Wimberly Ross, New York, NY (US)

(73) Assignee: Microsoft Corporation, Redmond, WA (US)

(21) Appl. No.: 12/619,711

(22) Filed: Nov. 17, 2009

(51) Int. Cl. G06F 15/173; G21C 17/00

(52) U.S. Cl. 709/224; 702/182

(57) ABSTRACT

Described is a technology by which a content server downloads an active content measuring tool object to a client request for a page. When loaded, the measuring tool object makes network measurements, including by direct socket access, and return measurement results. As part of its operations, the measuring tool object may request measurement assignments from a central controller, and/or return those results to the central controller. Measurement assignments may be directed towards determining a round trip time/latency, measuring throughput, packet loss rate, detecting in-fight modification of content and/or detecting the presence of a middle box, including the presence of a caching proxy server middle box. The measurement results may be used to evaluate hypothetical deployment of a number of servers and/or geographic locations for those servers.

### BACKGROUND

Cloud service providers are very interested in optimizing network performance. This may be done by including co-locating production servers in well-connected Internet eXchange (IX) points, deploying data centers in additional locations, and/or contracting with external Content Distribution Networks (CDNs), for example. These solutions can be very costly, yet even when implemented may not significantly improve performance.

As a result, before spending money on such major infrastructure changes, cloud service providers want to have a good estimate of the performance that can be gained by each of the various solutions to “what-if” type deployment and configuration questions. Typical “what-if” type questions seek to determine how service performance parameters, such as response time and/or throughput will be affected by deploying a new data center, or by changing the mapping of clients to servers.

Such estimates depend on accurately characterizing end-to-end performance between the end-user host and the cloud's servers. As is known, the so-called “last mile” to an end-user's location often dominates end-user performance. Thus, to make accurate predictions for client-server re-mapping, end-to-end latency/throughput performance from clients to servers needs to be accurately measured. Note that the accuracy of such methods can be significantly impaired by Internet middle boxes such as NAT, proxy and firewall, and the like.

Existing measurement techniques are based upon having measurement applications installed and executed in thousands of representative end-user clients that are geographically distributed around the world. However, end-users tend to avoid downloading and installing executables whenever possible, and generally do not make (or are incapable of making) even minor changes to their default system configurations.

As a result, client-side installation is a significant barrier to deployment of programs, let alone for a measurement tool that does not provide any immediate or direct benefit to end-users. Thus, it is desirable to provide a measurement tool that accurately measures end-to-end performance without requiring end-users to download and install programs and/or make changes to default system configurations.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a client downloads an active content measuring tool object in response to a request for content (a page) from that server. The client that receives the measuring tool object loads it while processing the page, which then runs to make network measurements, including by direct socket access, and return measurement results.

In operation, the object may request for one or more measurement assignments from a central controller, and/or return those results to the central controller. The measurement assignments may be directed towards determining a round trip time/latency. Other measurement assignments may include packet loss profile and measuring throughput.

The results may be used to evaluate hypothetical deployment. Other assignments/results may be directed towards detecting in-fight modification of content and/or detecting the presence of a middle box. For example, to detect the presence of a caching proxy server middle box, the measurement assignments may use header information to determine whether a response is received from a cache or from a server.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing an example architecture/system for obtaining network-related measurements via a client-loaded active content measuring tool object.

FIG. 2 is a flow diagram representing example steps performed by a central controller to provide the measuring tool object and work with a client to provide measuring assignments and receive measuring results.

FIG. 3 is a flow diagram representing example steps performed by a client that receives a measuring tool object.

FIG. 4 is a flow diagram representing example steps performed by a measuring tool object to determine round-trip-time to a server.

FIG. 5 shows an illustrative example of a computing environment into which various aspects of the present invention may be incorporated.

### DETAILED DESCRIPTION

Various aspects of the technology described herein are generally directed towards performing accurate network (e.g., Internet) performance measurement using active content. To this end, a cross-platform object (e.g., based on Silverlight® or Flash®) is employed as part of a new active-content tool for measuring the end-to-end performance between end-user systems and cloud entities. Further, object access at the socket level is described, as it provides for more accurate measurement and more variety with respect to performance parameter measurement.

It should be understood that any of the examples herein are non-limiting. For example, while a Silverlight® or Flash® object is described, Java® applets can also be used for such active content, since they are loaded within browsers and can also provide socket access, and have recently begun to support cross-domain access. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and networking in general.

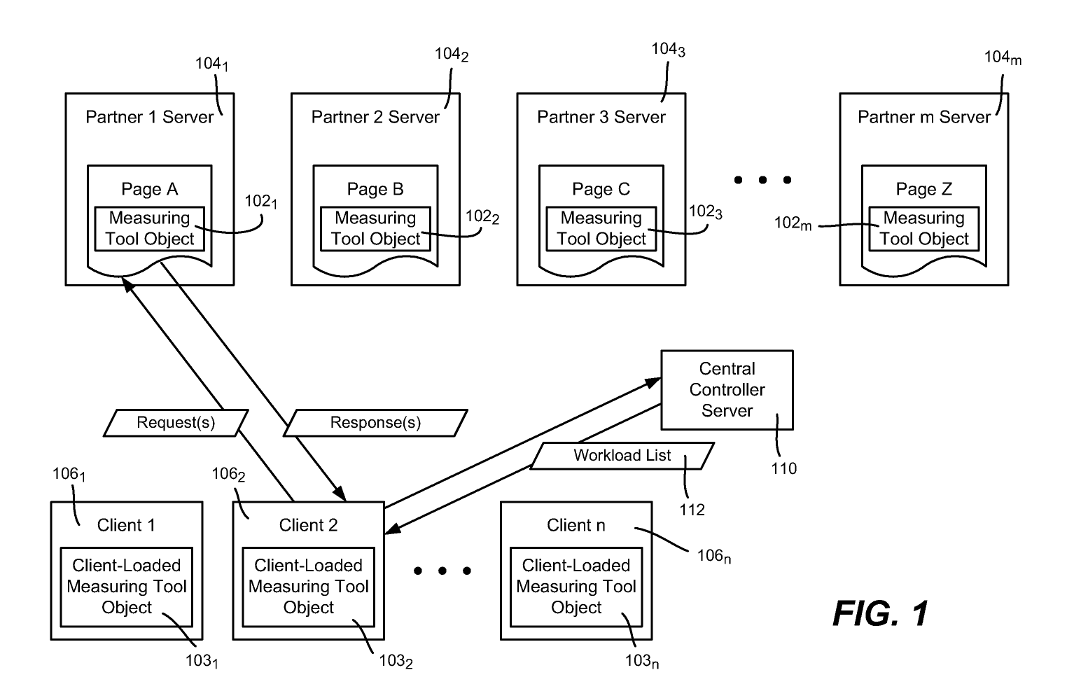

FIG. 1 shows various aspects related to the technology described herein, including instances of a measurement tool 102₁-102ₘ hosted on a number of partner web servers 104₁-104ₘ, e.g., a relatively large number of popular servers. In one implementation, the measurement tool comprises an object. When clients 106₁-106ₙ retrieve web pages from the servers' websites, an instance 103₁-103ₙ of the measurement tool object is loaded into each client 106₁-106ₙ. In FIG. 1, on example is represented by Client 2 (labeled 106₂ in FIG. 1) downloading page A that contains measurement tool (object) 102₁. The object may be at the end of the web page so as not to affect user-perceived page load time.

To obtain a more complete and accurate picture, cloud service providers may deploy the measuring tool objects at a large scale. By way of example, consider a cloud service provider offering a popular service, such as search, a portal, web mail, or social networking. If this service is supported by advertisements and offered to end users free of charge, deploying the measuring tool object is as straightforward from the service's perspective as “replacing” one of the advertisements with the measuring tool object. The service can also be deployed by replacing other object on the web page, e.g., an image icon. When the measuring tool object is loaded into an end-users' web browser, instead of displaying an advertisement or image icon, the tool performs a number of measurements. As with advertisement, the measuring tool object is launched without any end-user intervention. Note that a cloud service provider may purchase advertisement space from dedicated advertisement agencies, such as when it wants to reach a larger client population or target a specific demographic.

When the measurement tool object (e.g., 103₂) runs on the client, it works with a central controller 110 (e.g., at another, control server website, such as a server admeasure.com) to retrieve measurement assignments from the central controller 110. As described below, this allows measuring the round-trip-time (RTT) between a large number of clients and a target server under the system's control. Note that an alternative is to have the one or more assignments coded into the measuring tool.

The measurement assignments may be in the form of a workload list 112. With this configuration, the workload list 112 can be dynamically modified by the central controller 110. Further, updates to the measuring tool object may be uploaded to each of the partners' sites.

Note that the central controller 110 (the AdMeasure server) is normally not in the same domain as the partner's web server. However, such access is allowed by the configuration of a crossdomain.xml file on the central controller 110. More particularly, because modern web browsers enforce a policy known as the “same origin” policy, JavaScript® active content does not allow remotely and dynamically modifying measurement targets. However, Silverlight® or Flash® provide a more flexible security model such that with server-site cooperation, a Silverlight® or Flash® object can access cross-domain content. Thus, if the central controller 110 (admeasure.com) explicitly grants access to objects loaded from partner.com, the object 103₂ can retrieve content from the central controller 110 using the HTTP protocol. This access is granted with an XML file, crossdomain.xml, which takes the following form (note that this access does not require any client-side configuration):

<cross-domain-policy>
<allow-access-from domain=“partner.com”/>
</cross-domain-policy>

In addition to granting HTTP access, the central controller 110 (admeasure.com) can grant the measurement tool object (served by partner.com) direct TCP socket access. As a result, the browser running in the local client does not interfere with the communication between the measurement tool player and admeasure.com, because the HTTP request/reply exchange bypasses the internal HTTP transport engine of the browser. This allows for a more accurate round trip time (RTT) measurement between the client and the target web site. This measure may also be able to measure performance metrics that cannot be measured through HTTP transport, e.g., packet loss rate. In addition, in this mode, the browser does not cache the responses from admeasure.com; as described below, this property provides capability for detecting caching middle boxes.

For direct TCP socket access, Silverlight® provides for cross-domain socket communications between a Silverlight® application and any server, provided that an appropriate security policy file is in place on the server. With a Flash® player object, The XMLSocket object implements client sockets that allow computers running the player to communicate with a server computer identified by an IP address or domain name; to use the XMLSocket object, the server computer runs a daemon that understands the protocol used by the XMLSocket object.

Thus, for example, the central controller 110 may run a policy daemon (e.g., flashpolicyd:80) to grant the measurement tool object that was loaded from partner.com access to port 80 via TCP.

<cross-domain-policy>
<allow-access-from domain=“partner.com” port=“80”/>
</cross-domain-policy>

In this way, the measurement tool object in the client is able to establish a direct TCP connection with admeasure.com at port 80. To communicate with the central controller 110, the measurement tool object 103₂ may construct messages in the HTTP format; from the central controller's perspective, the request appears to have come from a regular browser.

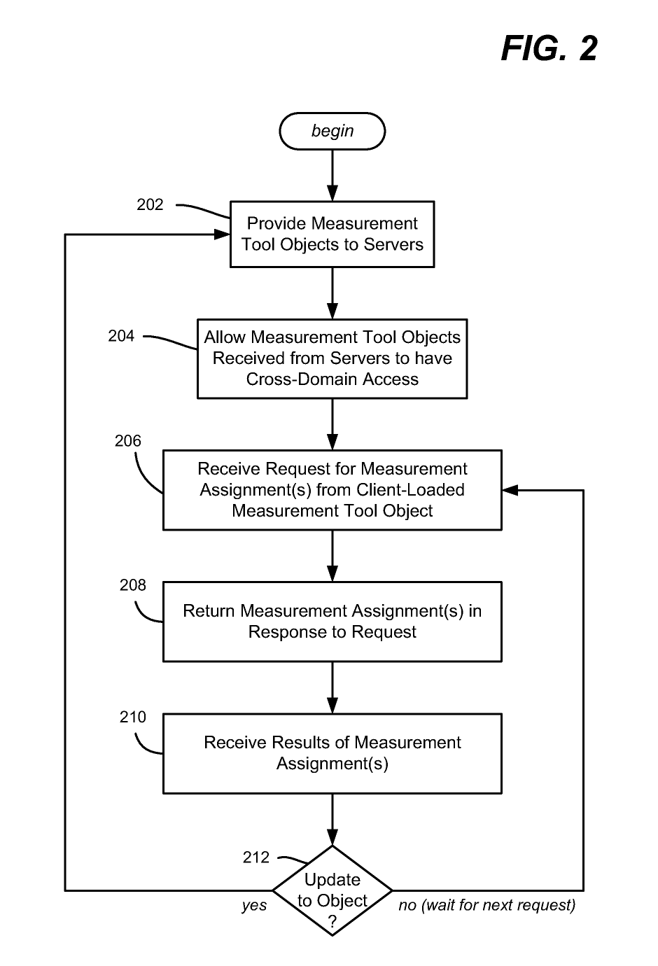

FIG. 2 shows some of example steps taken by the central controller; this may be one server/site, or different servers/sites working together, e.g., one to distribute the objects to servers, another to handle client requests. Step 202 represents providing the measurement tool objects to the servers, with step 204 representing the configuration of policy or the like on the central controller to allow the measurement tool objects cross domain access when the clients have received them from the servers.

Step 206 represents receiving a request for the measurement assignments, that is, a request for the workload list from the client that is running the active content object. Step 208 returns the measurement assignments; these may be selected as needed for a given measurement task that the central controller wants to have performed. Step 210 represents receiving the results, which may be used in various ways, such as to estimate deployment, detect middle boxes, detect in-flight modification to content and so forth, as described below.

In general, the central controller repeats this process as long as measurements are desired. As mentioned above, the objects may be updated or otherwise changed from time to time, as represented by step 212 returning to step 202 to upload updated objects to the servers. Note that it is feasible to have different measurement tool objects and/or versions of the objects on different servers, or even on different pages within the same server, or even on the same pages but targeting a different user base, for example.

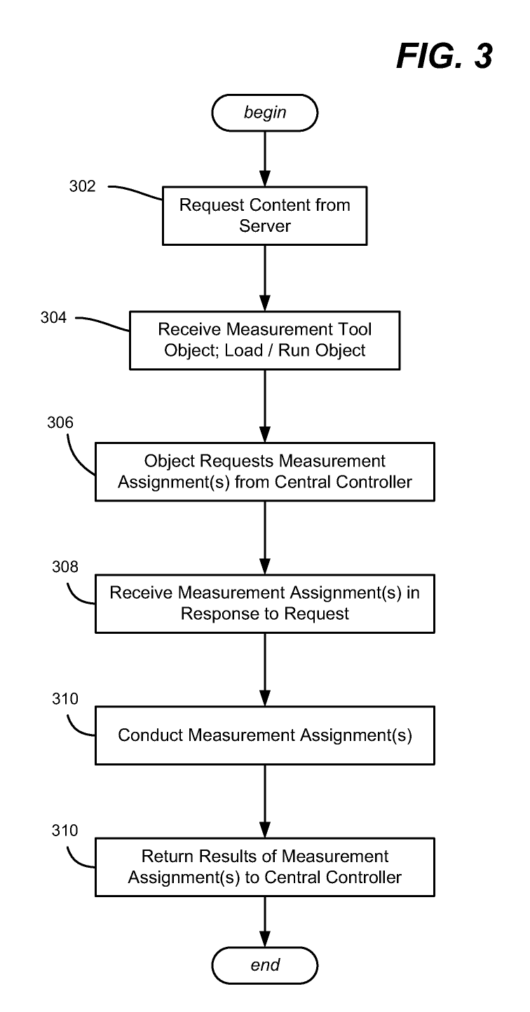

FIG. 3 shows similar example steps from the perspective of the client/object, beginning at step 302 where the client first requests content from a server that has the measurement tool object on a requested page. Step 304 represents receiving the tool, which is loaded and run as active content.

At step 306, the object requests the measurement assignment or assignments (e.g., the workload list) from the central controller 110. Based upon this list, received at step 308, the object on the client conducts the measurement assignments at step 310, and returns the results to the central controller (step 312).

Thus, after obtaining the workload list 112, the client 106₂ performs Internet measurements to hosts in the workload list and submits the results back to the central controller 110. In one implementation, the workload list (or lists) may be static, e.g., for evaluating RTT measurement accuracy and detecting middle boxes as described below, and/or dynamic e.g., for comparing CDN deployment and assessing hypothetical Cloud Service deployment. In the dynamic case, the workload list returned by the central controller 110 may depend on the client's origin. For example, the central controller 110 can return, from a large set of potential measurement targets, the target that is the closest to the client.

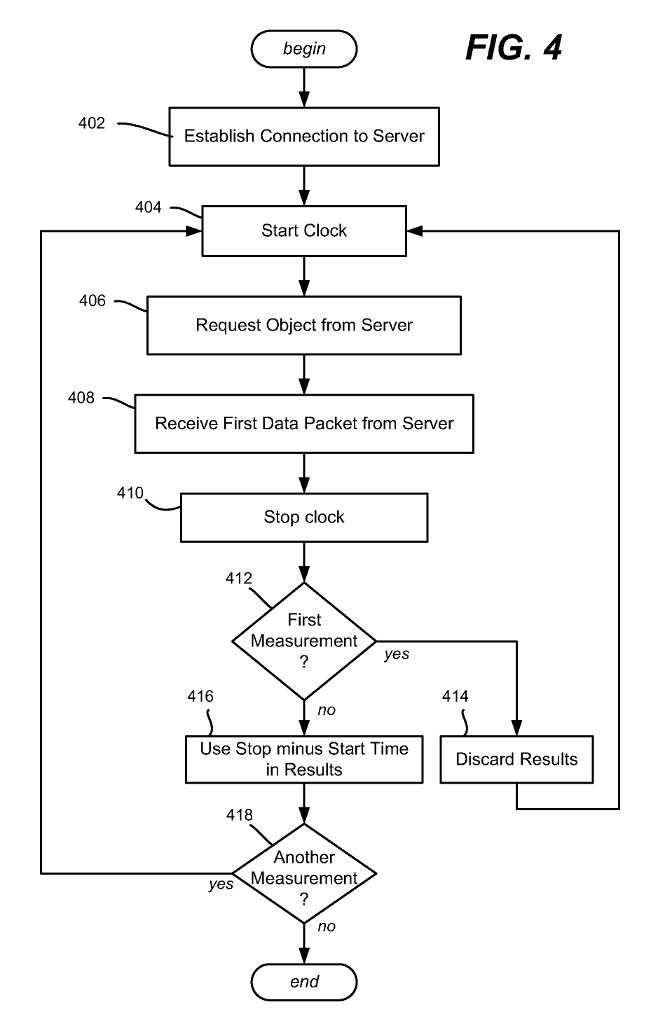

To obtain RTT measurements between a large number of clients and a target web server, when a client visits a partner site, the client is instructed to fetch a small object from the server. The time elapsed from when the client initiates the request until the response arrives at the client comprises the RTT, or latency. FIG. 4 shows example steps that may be taken to determine the RTT time/latency.

When using active web content to measure latency, to avoid TCP connection time, the server is configured with a large persistent connection count. In this system, using the socket level, the connection to port 80 is established at the target server, e.g., example.com (step 402). After the connection is in place, the HTTP request is sent (step 404), and a clock started (step 406). The clock is stopped when blocking read on the socket returns, which is when the first data packet is delivered (step 408 and 410). Note that the target server is configured to send a very small response (a few hundred bytes including the HTTP response header) to the client. As a result, the response can easily fit into one network packet. Moreover, unlike prior measurement approaches (e.g., Javascript) in which the HTTP request and reply is processed by the browser, the approach described herein bypasses the client browsers' parsing engine of the HTTP request and reply.

Note that the very first measurement is discarded, because it may take up to two round-trip times due to establishing a connection. Steps 412 and 414 represent this action.

Each subsequent HTTP request-response takes only one round trip to complete. Thus, after the first measurement, the stop time minus start time may be used in computing the round trip time (step 416). As represented by step 418, this result may be used in many ways by taking multiple measurements, e.g., as an average, as a minimum, as a maximum, as an average after discarding the highest and lowest results, as a medium, as a ninetieth-percentile, as a RTT histogram, and so forth.

In this manner, the system improves the accuracy of RTT measurements when there is server-side cooperation (as servers implement a policy that explicitly grants socket access). This works well for measuring latency from clients to a Cloud Service provider's own infrastructure, and thus helps answer important what-if questions, such as predicting performance after re-mapping clients from one front-end to another.

Other what-if questions relate to whether additional infrastructure deployments can help the cloud service provider. The tool can provide such measurement methodologies by leveraging existing large-scale networks. For latency measurement, one described methodology uses CDN infrastructures. For throughput measurements, one described methodology uses a SpeedTest or similar network. For packet loss measurement, one methodology is to use abnormally large delay to infer packet loss.

For the CDN latency methodology, the tool may be used to measure the latency between clients and a target CDN service provider using reflection pings. For example, consider that example.com maps to 192.168.0.1; if so, an HTTP request is constructed as: http://192.168.0.1/tiny.gif?rand, instead of http://example.com/tiny.gif?rand. Note that because the CDN server uses the hostname to associate a request with its customers (by examining the “Host” field in an HTTP request header), it cannot map http://192.168.0.1/tiny.gif?rand to any particular customer in this case. As a result, it denies such a request and sends back HTTP/1.x 400 Bad Request. In addition, the CDN server closes the connection after such a reply. Hence, each request (after the very first one) completes in exactly two RTTs (one for TCP establishment and the other for the request/reply). The final RTT latency is calculated as half of the measured elapsed time.

Note that to ensure accuracy, the client needs to avoid using a CDN server with which it currently has a persistent connection, for cases when the client has recently (e.g., within a normal persistent connection timeout of five minutes) requested content from example.com. A randomization technique may be used to minimize the probability of this occurring. In general, for a given CDN provider, each of its locations typically has many CDN servers. The client may thus be made to contact different CDN servers when repeatedly visiting the same CDN location. To this end, the list of servers for both CDN A and CDN B may be determined, and grouped by their geographic locations. For example, CDN A′s deployment covers more than 200 locations, while CDN B covers 18 locations. The central controller maintains a list of up to 32 active servers for each location, wherein the activeness of a CDN server is tested by having the central controller attempt a TCP connection with the CDN server at port 80. The list is randomly generated from all the servers in each location, and the list is refreshed every hour.

When a client requests a workload item, the central controller first decides the measurement target location, and then randomly selects a CDN server from the list corresponding to that location. In this manner, with high probability, the client contacts different CDN servers when repeatedly visiting the same CDN location (and therefore does not use persistent TCP connections). The client conducts reflection pings several times to the randomly chosen server, and RTT between the client and this location is estimated as the minimum latency. To determine the closest CDN location, the client's IP address is mapped into a geographic location (longitude and latitude) using a reverse location database, with the minimum great circle distance to all CDN locations selected. Note that this method of determining the closest CDN location is only approximate, as it does not take into account dynamic network conditions, network routing and peering decisions.

With respect to the evaluating throughput measurement methodology, another infrastructure such as the SpeedTest network (ww.speedtest.net) may be used to download large objects. A user is allowed to choose a location, such as a highlighted one that is closest in geographic distance to the user's location; most users tend to choose the highlighted one. Through a series of HTTP requests/responses, the network provides the user with the estimated latency, as well as with the estimated download and upload bandwidths to the selected server. To measure latency, a small (e.g., text) file is requested multiple times. To measure bandwidth, a large (e.g., image) file is requested multiple times. The small file is used to approximately estimate bandwidth, with the large file chosen to have an appropriate size that ensures that the download time is not too short.

With respect to evaluating packet loss rate via the measurement methodology, the client may conduct a large number of RTT measurements to the server. A RTT histogram profile between the client and the server may then be established, to detect the probability of any RTT being abnormally large in the RTT histogram. Such an abnormally large RTT can be attributed to packet loss, where the TCP request/response packet is lost, timed out, and retransmitted again. Thus, percentage of abnormally large RTT may be used to measure the packet loss rate between the client and the server.

The performance of a cloud service is, in principle, closely tied to the extent of its geographic deployment, i.e., how close it is to the end-users. However, extensive deployment requires high capital costs. It is thus desirable to investigate the tradeoff between deployment scale and performance.

By using the above-described methodologies, the two CDN deployment philosophies may be compared. Then, for cloud services in general (including CDN providers), an answer as to the number of data centers that the service should provide, and where they should be located, may be provided. Using the technology described herein provides the answer without needing to predict by deploying servers in hundreds of potential locations, and then to measure latency and throughput performance from end-users to these servers, which is very expensive.

More particularly, the following describes one methodology for evaluating hypothetical deployment as to how many locations should a deployment contain and where these locations should be. Assume that the infrastructure has M (with M>200) potential locations. In general, the task is to pick a subset (e.g., N sites, with N much less than M) to form a smaller-scale deployment. Using the technology described herein allows an evaluation of the performance of this hypothetical deployment. By varying N, the methodology can quantify the tradeoff between deployment scale and performance.

The question then turns to selecting the N sites out of the total M potential locations. To this end, the following heuristic method may be used. The heuristic method start with an initial deployment (which may be empty), finds the best additional location from the remaining locations, and adds this location to the current deployment. During this process, each additional location L is examined by constructing a hypothetical deployment D′, which comprises the current deployment D plus this location L. The performance from each client C to the hypothetical deployment D′ is then evaluated.

Aggregation across the clients yields a score for L, and the process chooses the location L that has the highest score. The process continues to add locations one at a time until the deployment contains the desirable number of locations. The following pseudo-code explains the process of finding the best next location:

```
// D: {locations of current deployment}
find_best_next_location(D)
  foreach L in remaining locations
    // D′: hypothetical new deployment
    D′ = D + {L}
    foreach C in all clients
      sum = sum + best_performance(C, D′)
    if sum has reduced
      best_next_location = L
return best_next_location
```

The above process takes measurements from each client to all the M locations. The measurement load may be prohibitively high. As an alternative, the following geographic distance-based method may be used to choose deployment configurations. The method first obtains the client population of a targeted cloud service and maps each client into a location atom (a latitude-longitude tuple) by its IP address. Multiple clients can be mapped to the same location atom. The best performance between a client and a given deployment is approximated by the great circle distance between the client and the closest location in the deployment. In this simplified method, finding the best next location becomes:

```
// D: {locations of current deployment}
find_best_next_location(D)
  foreach L in remaining locations
    // D′: hypothetical new deployment
    D′ = D + {L}
    foreach A in all location atoms
      d = min_geographic_distance(A, D′)
      sum = d * (total clients in A)
    if sum has reduced
      best_next_location = L
return best_next_location
```

Middle boxes, such as NAT, firewall and proxy server, are an important part of Internet infrastructure. It is valuable to know how widely middle boxes are deployed in different ISPs and geographical locations. For example, as NAT/firewall are widely deployed, a P2P file sharing application will not work well if it does not handle NAT traversal or firewall relay well. Among the middle boxes, proxy server is especially difficult to detect. However, detecting proxy server can help server operators make informed decisions on whether it will be effective to enforce access control or make targeted advertisements based on IP addresses.

Described herein is a new method to detect proxy server with caching. As described above, with a socket, the measurement tool can emulate HTTP communication with a remote web server, while bypassing the client-side browser cache. This property allows detecting proxy servers with caching.

To this end, once the measurement tool object is loaded by a client, it creates a random URL for a one-pixel GIF or the like. The tool then repeatedly requests this GIF from a modified web server, under the system's control, in the HTTP protocol format. The controller web server records the HTTP header information of the request whenever it presents, such as “via”, “forward”, and so forth, so that it can detect the existence of the proxy server by the HTTP header.

In addition, the controller web server is configured such that it not only replies with a one-pixel GIF to such random requests, but also adds an “ETag” in the reply HTTP header. The ETag is generated dynamically based on the request time and is thereby different for every reply. When there is a proxy server with caching along the path between the client and the server, it will cache the first reply and respond immediately from its cache to subsequent same requests. In other words, the client will get the GIF from the proxy server directly for subsequent requests with the same ETags. If there is no proxy server in the middle, the client will get the GIF object directly from the controller web server each time with different ETags. By comparing the ETags retrieved for the GIF object, AdMeasure can decisively detect the existence of the proxy server. As the client fetches the GIF object from the proxy server's cache (if it exists) after the first request, the latencies for subsequent requests indicate the proximity between the client and its proxy server. In this manner, the system is thus able to detect a proxy server even when the client and its proxy are very close, which cannot be detected using other known (e.g., RTT analysis) methods.

Yet another use of active web content is to detect changes to a web page that have been made “in-flight” between a client and an origin server. Many such in-flight modifications are undesirable, and some may have serious consequences, such as injecting malware exploits.

Using the measuring tool and methodology described herein, an in-flight modification detection tool may be implemented in an object and hosted at a single place, e.g., the central controller (e.g., admeasure.com). Any site wanting to detect in-flight modifications embeds a link to the object in their web pages, and sets up a cross-domain XML policy file to grant access to itself by such objects loaded from the central controller.

When a client loads web pages from the site, it will run the object. The object can then retrieve content from the site (cross-domain) and detect whether the content has been modified.

### Exemplary Operating Environment

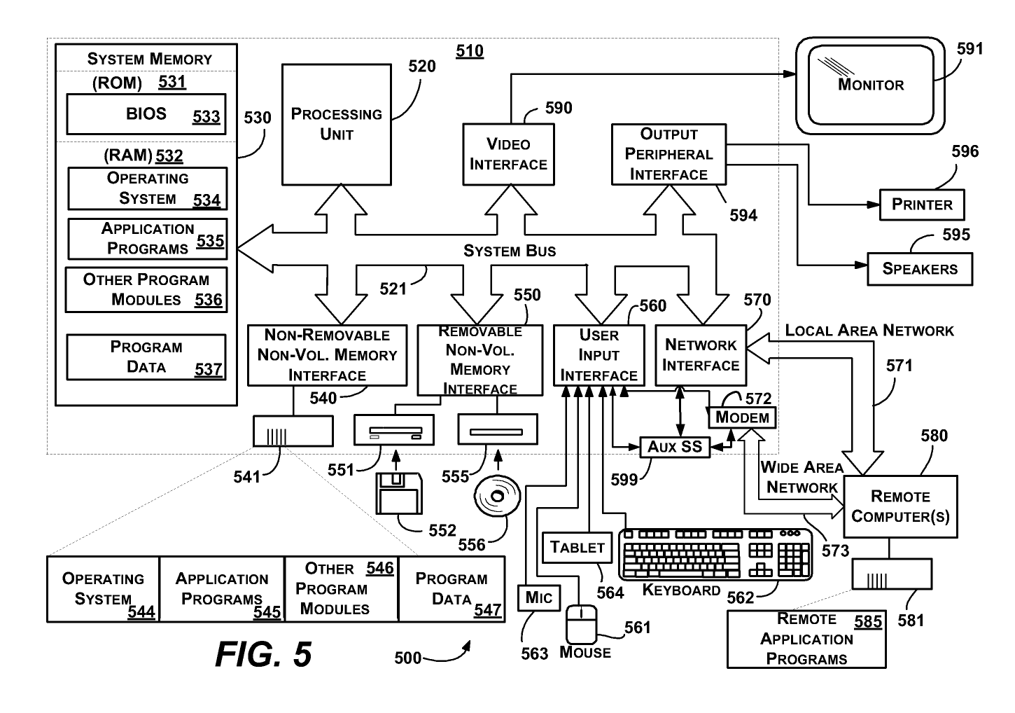

FIG. 5 illustrates an example of a suitable computing and networking environment 500 on which the examples of FIGS. 1-6 may be implemented. The computing system environment 500 is only one example of a suitable computing environment and is not intended to suggest any limitation as to the scope of use or functionality of the invention. Neither should the computing environment 500 be interpreted as having any dependency or requirement relating to any one or combination of components illustrated in the exemplary operating environment 500.

The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 5, an exemplary system for implementing various aspects of the invention may include a general purpose computing device in the form of a computer 510. Components of the computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 510 typically includes a variety of computer-readable media. Computer-readable media can be any available media that can be accessed by the computer 510 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 510. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536 and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media, described above and illustrated in FIG. 5, provide storage of computer-readable instructions, data structures, program modules and other data for the computer 510. In FIG. 5, for example, hard disk drive 541 is illustrated as storing operating system 544, application programs 545, other program modules 546 and program data 547. Note that these components can either be the same as or different from operating system 534, application programs 535, other program modules 536, and program data 537. Operating system 544, application programs 545, other program modules 546, and program data 547 are given different numbers herein to illustrate that, at a minimum, they are different copies. A user may enter commands and information into the computer 510 through input devices such as a tablet, or electronic digitizer, 564, a microphone 563, a keyboard 562 and pointing device 561, commonly referred to as mouse, trackball or touch pad. Other input devices not shown in FIG. 5 may include a joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590. The monitor 591 may also be integrated with a touch-screen panel or the like. Note that the monitor and/or touch screen panel can be physically coupled to a housing in which the computing device 510 is incorporated, such as in a tablet-type personal computer. In addition, computers such as the computing device 510 may also include other peripheral output devices such as speakers 595 and printer 596, which may be connected through an output peripheral interface 594 or the like.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include one or more local area networks (LAN) 571 and one or more wide area networks (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560 or other appropriate mechanism. A wireless networking component such as comprising an interface and antenna may be coupled through a suitable device such as an access point or peer computer to a WAN or LAN. In a networked environment, program modules depicted relative to the computer 510, or portions thereof, may be stored in the remote memory storage device. By way of example, and not limitation, FIG. 5 illustrates remote application programs 585 as residing on memory device 581. It may be appreciated that the network connections shown are exemplary and other means of establishing a communications link between the computers may be used.

An auxiliary subsystem 599 (e.g., for auxiliary display of content) may be connected via the user interface 560 to allow data such as program content, system status and event notifications to be provided to the user, even if the main portions of the computer system are in a low power state. The auxiliary subsystem 599 may be connected to the modem 572 and/or network interface 570 to allow communication between these systems while the main processing unit 520 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method performed on at least one processor, comprising:
providing a measuring tool object to a server for downloading in response to a request for content from that server, the measuring tool object comprising active content configured to make network measurements by direct socket access;
receiving a request for one or more measurement assignments from the measuring tool object the one or more measurement assignments directed towards determining network performance; and
providing the one or more measurement assignments in response to the request.

2. The method of claim 1, wherein the one or more measurement assignments directed towards determining network performance correspond to measuring round trip time, measuring throughput, or measuring packet loss rate, or any combination of measuring round trip time, measuring throughput, or measuring packet loss rate.

3. The method of claim 1, wherein the one or more measurement assignments directed towards determining network performance correspond to obtaining a minimum value representing the network performance, a maximum value representing the network performance, a medium value representing the network performance, a ninetieth-percentile value representing the network performance, or a histogram of a network performance value set, or any combination of a minimum value representing the network performance, a maximum value representing the network performance, a medium value representing the network performance, a ninetieth-percentile value representing the network performance, or a histogram of a network performance value set

4. The method of claim 1 wherein a central controller that is cross domain with respect to the server receives the request and provides the one or more measurement assignments, and further comprising, configuring the central controller to allow access to requests from objects loaded from the server, and configuring the server to allow socket access by the object.

5. The method of claim 1 wherein a measurement assignment comprises a request to determine a round trip time, and wherein the object performs the measurement assignment by establishing a connection to a port at a target server via direct socket access, sending an HTTP request via the connection, receiving a data packet in response, and determining the round trip time based upon a time of sending the HTTP request and a time of receiving the data packet in response.

6. The method of claim 1 wherein a measurement assignment comprises a request to measure latency between a client and a specified content distribution network server via at least one reflection ping.

7. The method of claim 1 wherein a measurement assignment comprises measuring throughput via a series of HTTP requests and responses.

8. The method of claim 1 further comprising, using at least one of the measurement assignments to evaluate hypothetical deployment.

9. The method of claim 1 further comprising, using at least one of the measurement assignments to detect the presence of a middle box.

10. The method of claim 1 further comprising, using at least one of the measurement assignments and a direct socket access connection to detect the presence of a proxy server, including using header information to determine whether a response is received from a cache or from a server.

11. The method of claim 1 further comprising, using at least one of the measurement assignments to detect in-fight modification of content.

12. In a computing environment, a system comprising, a server that returns a page of content in response to requests, the page including an active content measuring tool object that requests one or more measuring assignments from a central controller, and the server configured to allow socket access by the active content measuring tool object to conduct the one or more measuring assignments.

13. The system of claim 12 wherein the server receives the active content measuring tool object from the central controller.

14. The system of claim 12 wherein a client process the page to load and run the measuring tool object, including to request and receive the one or more measuring assignments from the central controller, to conduct the one or more measuring assignments, and to return result of the one or more measuring assignments to the central controller.

15. In a computing environment, a method performed on at least one processor, comprising:
providing a measuring tool object from a central controller to a server, the measuring tool comprising active content configured to make network measurements;
downloading the measuring tool from the server as part of a set of content returned to requesting clients; and
receiving results at the central controller of network-related measurements made by the measuring tools of at least some of the clients.

16. The method of claim 15 further comprising, receiving a request for one or more measurement assignments from the measuring tool object, and providing the one or more measurement assignments in response to the request.

17. The method of claim 15 wherein receiving the results comprises receiving a round trip time measurement to a server.

18. The method of claim 15 further comprising, using the results to evaluate hypothetical deployment.

19. The method of claim 15 further comprising, using the results to detect the presence of a middle box.

20. The method of claim 15 further comprising, using the results to detect in-fight modification of content.
